(19) United States
(12) Patent Application Publication
(10) Pub. No.: US 2024/0022394 A1
(43) Pub. Date: Jan. 18, 2024

(54) METHOD AND SYSTEM FOR PROVIDING COMPUTING DEVICE FOR EACH COMPUTING POWER BASED ON PREDICTION OF COMPUTING POWER REQUIRED FOR FULLY HOMOMORPHIC ENCRYPTION IN A CLOUD ENVIRONMENT

(71) Applicants: NAVER CLOUD CORP., Seongnam-si (KR); CRYPTO LAB INC., Seoul (KR)

(72) Inventors: Oh Hyun KWON, Seongnam-si (KR); Kyuhwan YUN, Seongnam-si (KR); Munsu KWAK, Seongnam-si (KR); Hyun Min CHOI, Seongnam-si (KR); Ae Ji KIM, Seongnam-si (KR); Jae Seon KIM, Seoul (KR); Younggi LEE, Seoul (KR)

(21) Appl. No.: 18/351,707

(22) Filed: Jul. 13, 2023

(30) Foreign Application Priority Data
Jul. 13, 2022 (KR) 10-2022-0086397

(51) Int. Cl. H04L 9/00; H04L 9/08

(52) U.S. Cl. CPC H04L 9/008; H04L 9/0861

(57) ABSTRACT

A method and a system provide a computing device for each computing power based on prediction of computing power required for fully homomorphic encryption in a cloud environment. A computing device providing method may be performed by a computer device including at least one processor. The computer device may implement at least one node included in the cloud environment. The computing device providing method may include providing, to a client device, a management tool including an application function of a computing device that processes a homomorphic encryption operation, and recommending the computing device for processing of the homomorphic encryption operation requested through the management tool.

### CROSS-REFERENCE TO RELATED APPLICATION(S)

This U.S. non-provisional application claims the benefit of priority under 35 U.S.C. § 119 to Korean Patent Application No. 10-2022-0086397 filed on Jul. 13, 2022, in the Korean Intellectual Property Office (KIPO), the entire contents of which are incorporated herein by reference.

### BACKGROUND OF THE INVENTION

### Field of Invention

One or more example embodiments of the invention in the following description relate to a method and system for providing a computing device for each computing power based on prediction of computing power required for fully homomorphic encryption in a cloud environment.

### Description of Related Art

Homomorphic encryption refers to an encryption algorithm in which a result value (A) acquired by performing an operation on data (plaintext) is the same as a decryption result value (B) of a value acquired by performing an operation on the plaintext in an encrypted state.

Existing encryption technologies cannot perform tasks, such as operation, analysis, and search, on data in an encrypted state. Therefore, the existing encryption technologies have technical limitations in that, if statistical analysis of certain encrypted data is to be performed, a corresponding task needs to be performed with the plaintext acquired after decryption. In contrast, homomorphic encryption enables an operation of the plaintext in an encrypted state and accordingly, may directly perform various tasks on encrypted data.

However, homomorphic encryption has a disadvantage that a ciphertext size is dozens of times greater than a plaintext size and a key size required for homomorphic encryption is considerably large compared to existing encryption algorithms, such as a Rivest-Shamir-Adleman (RSA) algorithm. Also, homomorphic encryption has a disadvantage that an operation speed within homomorphic encryption is dozens of times slower than an operation speed of the plaintext. For example, in homomorphic encryption, there is an allowed number of multiplications, so if a multiplication of greater than or equal to a depth allowed in homomorphic encryption is performed, a decrypted value may be unreliable. That is, as a multiplication repeats in homomorphic encryption, noise may increase, which makes it impossible to perform a multiplication corresponding to a certain number of times or more. Here, the ciphertext size and the key size increase as an allowable depth increases, that is, as the number of multiplications allowed increases.

Meanwhile, unlike a homomorphic encryption algorithm, proposed is fully homomorphic encryption as an encryption algorithm in which the number of multiplications is not limited. Fully homomorphic encryption uses rebooting (bootstrap or bootstrapping) as a process of reducing noise increased by multiplication.

Reference material includes, for example, Korean Patent Registration No. 10-1919940.

### BRIEF SUMMARY OF THE INVENTION

One or more example embodiments provide a method and system that may provide a computing device required for an operation using homomorphic encryption in a cloud environment.

According to at least one example embodiment, there is provided a computing device providing method performed by a computer device including at least one processor, wherein the computer device implements at least one node included in a cloud environment. The computing device providing method includes providing, by the at least one processor, a management tool including an application function of a computing device processing a homomorphic encryption operation to a client device; and recommending, by the at least one processor, the computing device for processing of the homomorphic encryption operation requested through the management tool.

According to one aspect of the invention, the computing device may include a virtual device provisioned with an environment for processing of the homomorphic encryption operation.

According to another aspect, the environment for processing of the homomorphic encryption operation may include an environment in which a library for homomorphic encryption is installed.

According to still another aspect, the recommending of the computing device may include recommending the computing device for processing of the requested homomorphic encryption operation based on at least one of the type of the homomorphic encryption operation, the number of homomorphic encryption operations, a homomorphic encryption scheme, and the type of a parameter of homomorphic encryption.

According to still another aspect, the type of the parameter may be classified according to at least one of the number of multiplication operations allowed, the speed of the homomorphic encryption operation, the accuracy of the homomorphic encryption operation, the capacity of homomorphic ciphertext, and the availability of rebooting (bootstrap).

According to still another aspect, the recommending of the computing device may include recommending the computing device for processing of the requested homomorphic encryption operation based on at least one of the size of data for the homomorphic encryption operation and the execution time expected for processing the homomorphic encryption operation.

According to still another aspect, the homomorphic encryption operation processed by the computing device may include an operation that requires rebooting (bootstrap) and an operation that does not require rebooting.

According to still another aspect, the homomorphic encryption operation processed by the computing device may include at least one operation among a constant operation for constant data, a column operation for matrix-type data, a statistical operation using the matrix-type data for statistics of a target, a categorical operation for processing an operation on values that meet a condition among values of a specific column, and a machine learning operation for learning and inference of machine learning.

According to still another aspect, the computing device providing method may further include, in response to a selection on the recommended computing device through the management tool, providing, by the at least one processor, a virtual image of the selected computing device.

According to still another aspect, the management tool may further include a key generation function for generation of a key.

According to still another aspect, the management tool may further include encryption and decryption functions for encryption and decryption of data for the homomorphic encryption operation.

According to still another aspect, the management tool may further include a return function of the computing device and a history management function according to application and return of the computing device.

According to at least one example embodiment, there is provided a non-transitory computer-readable recording medium storing instructions that, when executed by a processor, cause the processor to perform the computing device providing method.

According to at least one example embodiment, there is provided a computer device including at least one processor configured to execute computer-readable instructions in the computer device that implements at least one node included in a cloud environment, wherein the at least one processor is configured to provide, to a client device, a management tool including an application function of a computing device that processes a homomorphic encryption operation, and to recommend the computing device for processing of the homomorphic encryption operation requested through the management tool.

According to some example embodiments, it is possible to provide a computing device required for an operation using homomorphic encryption in a cloud environment.

According to some example embodiments, it is possible to predict computing power required for an operation using homomorphic encryption and to recommend a computing device for each computing power based on the predicted computing power.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram illustrating an example of a network environment according to at least one example embodiment;

FIG. 2 is a diagram illustrating an example of a computer device according to at least one example embodiment;

FIG. 3 is a diagram illustrating an example of a cloud environment according to at least one example embodiment; and

FIG. 4 is a flowchart illustrating an example of a method of providing a computing device according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature (s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flowcharts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, some example embodiments will be described with reference to the accompanying drawings.

A computing power prediction system and a computing device providing system according to the example embodiments may be implemented by at least one computer device. For example, the computing power prediction system and the computing device providing system may be implemented by different computer devices and may also be implemented by the same computer device. Here, a computer program according to an example embodiment may be installed and executed on the computer device that implements the computing power prediction system and/or the computing device providing system, and the computer device may perform a computing power prediction method and a computing device providing method according to the example embodiments under the control of the executed computer program. The aforementioned computer program may be stored in a computer-readable storage medium to computer-implement the computing power prediction method and the computing device providing method in conjunction with the computer device.

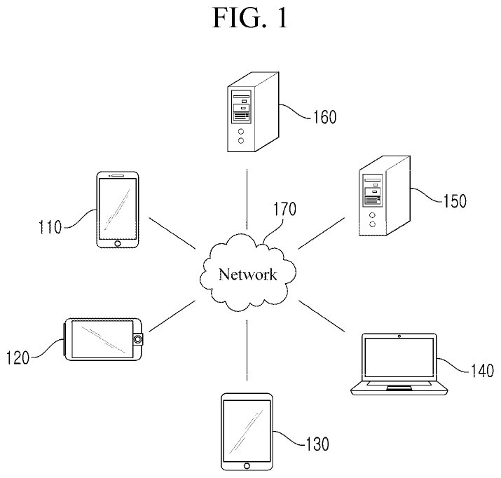

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. The number of electronic devices or the number of servers shown is not limited thereto.

Each of the plurality of electronic devices 110, 120, 130, and 140 may be a fixed terminal or a mobile terminal that is configured as a computer system. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet personal computer (PC), a game console, a wearable device, an Internet of things (IoT) device, a virtual reality (VR) device, an augmented reality (AR) device, and the like. For example, although FIG. 1 illustrates a shape of a smartphone as an example of the electronic device 110, the electronic device 110 used herein may refer to one of various types of physical computer systems capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, a satellite network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer system or a plurality of computer systems that provides an instruction, a code, a file, content, a service, etc., through communication with the plurality of electronic devices 110, 120, 130, and 140 over the network 170. For example, the server 150 may be a system that provides a first service to the plurality of electronic devices 110, 120, 130, and 140 connected over the network 170, and the server 160 may be a system that provides a second service to the plurality of electronic devices 110, 120, 130, and 140 connected over the network 170. In detail, for example, the server 150 may provide a service, for example, a cloud service, desired by a corresponding application to the plurality of electronic devices 110, 120, 130, and 140, as the first service through the application as a computer program that is installed and executed on the plurality of electronic devices 110, 120, 130, and 140. As another example, the second server 160 may provide a service for distributing a file for installation and execution of the aforementioned application to the plurality of electronic devices 110, 120, 130, and 140 as the second service.

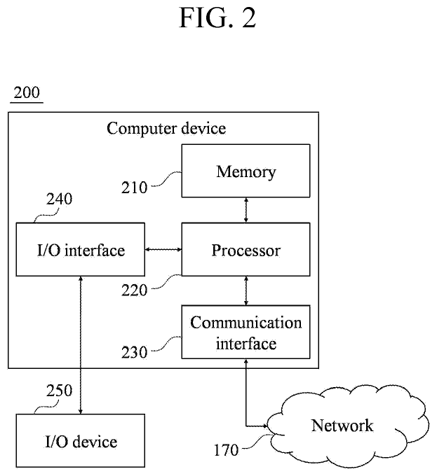

FIG. 2 is a block diagram illustrating an example of a computer device according to at least one example embodiment. Each of the plurality of electronic devices 110, 120, 130, and 140 of FIG. 1 or each of the servers 150 and 160 may be implemented by a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable record medium. The permanent mass storage device, such as ROM and a disk drive, may be included in the computer device 200 as a permanent storage device separate from the memory 210. Also, an OS and at least one program code may be stored in the memory 210. Such software components may be loaded to the memory 210 from another non-transitory computer-readable record medium separate from the memory 210. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 210 through the communication interface 230, instead of the non-transitory computer-readable record medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the communication apparatus 200 and another apparatus, for example, the aforementioned storage devices, over the network 170. For example, the processor 220 of the computer device 200 may forward a request or an instruction created based on a program code stored in the storage device such as the memory 210, data, and a file, to other apparatuses over the network 170 under the control of the communication interface 230. Inversely, a signal, an instruction, data, a file, etc., from another apparatus may be received at the computer device 200 through the communication interface 230 of the computer device 200 over the network 170. For example, a signal, an instruction, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device of the I/O device 250 may include a device, such as a microphone, a keyboard, a mouse, etc., and an output device of the I/O device 250 may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

According to other example embodiments, the computer device 200 may include greater or less number of components than those shown in FIG. 2. For example, the computer device 200 may include at least a portion of the I/O device 250, or may further include other components, for example, a transceiver, a database, etc.

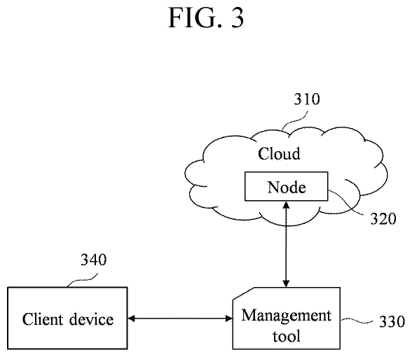

FIG. 3 is a diagram illustrating an example of a cloud environment according to at least one example embodiment. FIG. 3 illustrates a cloud 310, a node 320 included in the cloud 310, a management tool 330, and a client device 340.

Here, the node 320 may be implemented by at least one of a plurality of computer devices that implement the cloud 310 and each of the plurality of computer devices may correspond to the computer device 200 of FIG. 2.

Also, an agent may be installed and executed on the client device 340, and the client device 340 may be provided with a service by accessing the cloud 310 through the agent.

Here, the node 320 may provide a virtual image of a computing device capable of processing a homomorphic encryption operation to the client device 340 that desires the computing device for processing of the homomorphic encryption operation. In this case, the client device 340 may process the homomorphic encryption operation using the computing device provided through the virtual image. The cloud 310 may provide the computing device in a form of, for example, a Platform as a Service (PaaS). Substantially, processing of the homomorphic encryption operation may be performed on the cloud 310.

Here, as described above, the homomorphic encryption operation has a characteristic that a specific operation may be efficiently performed in a graphics processing unit (GPU) environment rather than a central processing unit (CPU) environment and has a great difference in performance required for processing of an operation according to the type of the homomorphic encryption operation, the number of homomorphic encryption operations, the homomorphic encryption scheme, the type of a parameter of homomorphic encryption, the size of data for the homomorphic encryption operation, and/or the execution time expected to process the homomorphic encryption operation. Here, the type of the parameter may be classified according to at least one of the number of multiplication operations allowed, the speed of the homomorphic encryption operation, the accuracy of the homomorphic encryption operation, the capacity of homomorphic ciphertext, and the availability of rebooting (bootstrap).

The node 320 may recommend a computing device with performance suitable for the homomorphic encryption operation a user desires to process to the user according to the characteristic of the homomorphic encryption operation and may forward a virtual image of the computing device selected by the user to the client device 340.

Therefore, the node 320 may provide the management tool 330 including an application function to the client device 340, such that the client device 340 may select data and/or the homomorphic encryption operation and may apply the computing device with suitable performance. For example, the node 320 may determine a computing device to recommend to the client device 340 based on information input or selected from the client device 340 through the management tool 330 (e.g., information on a homomorphic encryption operation and/or information on data to be processed through the corresponding homomorphic encryption operation). That is, the node 320 may predict computing power suitable for the input or selected information and may recommend at least one computing device having the predicted computing power to the client device 340 through the management tool 330. Here, when the recommended computing device is selected by the client device 340, the node 320 may provide a virtual image of the selected computing device to the client device 340.

Also, in addition to the application function of the computing device, the management tool 330 may further provide a key generation function for generation of a key, encryption and decryption functions for encryption and decryption of data for the homomorphic encryption operation, a return function of the computing device, and/or a history management function according to application and return of the computing device. As described above, when the user receives the management tool 330 from the node 320 by accessing the cloud 310 through the client device 340, the user may be provided with the computing device for processing of the user's desired homomorphic encryption operation using functions of the management tool 330 and may be provided with various functions of a service for the homomorphic encryption operation.

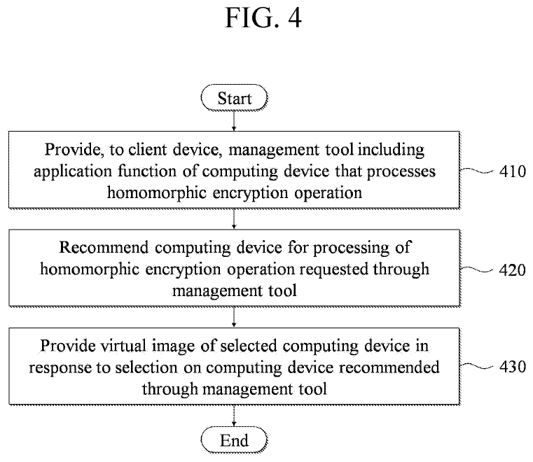

FIG. 4 is a flowchart illustrating an example of a computing device providing method according to at least one example embodiment. The computing device providing method according to the example embodiment may be performed by the aforementioned computer device 200 that implements, for example, the node 320. Here, the processor 220 of the computer device 200 may be implemented to execute a control instruction in response to a control instruction according to a code of at least one computer program or a code of an OS included in the memory 210. Here, the processor 220 may control the computer device 200 such that the computer device 200 may perform operations 410 to 430 included in the method of FIG. 4 in response to a control instruction provided from a code stored in the computer device 200.

In operation 410, the computer device 200 may provide, to the client device 340, the management tool 330 including an application function of a computing device that processes a homomorphic encryption operation. Here, the computing device may include a virtual device provisioned with an environment for processing of the homomorphic encryption operation, and the environment for processing of the homomorphic encryption operation may include an environment in which a library for homomorphic encryption is installed. For example, the library may include homomorphic encryption for arithmetic of approximate numbers (HEaaN) of Cheon-Kim-Kim-Song (CKKS) developed for fully homomorphic encryption. The CKKS is named after initials of developers and is a fully homomorphic encryption algorithm that basically supports a fixed-point approximate arithmetic calculation and significantly improves performance using an approximate calculation method. The HeaaN is a library that implements this CKKS scheme. Depending on example embodiments, a library of a different homomorphic encryption algorithm described below may be used.

As described above, the management tool 330 may further include a key generation function for generation of a key, encryption and decryption functions for encryption and decryption of data for the homomorphic encryption operation, a return function of the computing device, and/or a history management function according to application and return of the computing device in addition to an application function. Depending on example embodiments, generation of the key and/or encryption and decryption of data may be directly performed by the client device 340 through the agent and the management tool 330.

Also, the homomorphic encryption operation processed by the computing device may include at least one operation among a constant operation for constant data, a column operation for matrix-type data, a statistical operation using the matrix-type data for statistics of a target, a categorical operation for processing an operation on values that meet a condition among values of a specific column, and a machine learning operation for learning and inference of machine learning. Here, some operations may require rebooting (bootstrap or bootstrapping) and some operation may not require rebooting. As described above, if the homomorphic encryption operation is repeated, noise increases and decryption becomes impossible and accordingly, a process of reducing noise is required, which is called rebooting.

In operation 420, the computer device 200 may recommend the computing device for processing of the homomorphic encryption operation requested through the management tool 330. For example, the computer device 200 may recommend the computing device for processing of the requested homomorphic encryption operation based on at least one of the type of the homomorphic encryption operation, the number of homomorphic encryption operations, the homomorphic encryption scheme, the type of a parameter of homomorphic encryption, the size of data for the homomorphic encryption operation, and/or the execution time expected to process the homomorphic encryption operation. Here, the type of the parameter may be classified according to at least one of the number of multiplication operations allowed, the speed of the homomorphic encryption operation, the accuracy of the homomorphic encryption operation, the capacity of homomorphic ciphertext, and the availability of rebooting (bootstrap). Here, the execution time may be a value that is predicted according to at least one of the type of the key, the type of the homomorphic encryption operation, and the size of data.

In operation 430, in response to the selection of the recommended computing device through the management tool 330 by the client device 340, the computer device 200 may provide a virtual image of the selected computing device to the client device 340. The client device 340 may use the computing device as a virtual device that is provided in the cloud environment using the virtual image. Also, the client device 340 may process various homomorphic encryption operations using the computing device provisioned with an environment for processing of the homomorphic encryption operation, that is, the computing device in which a library for homomorphic encryption is installed.

The following Table 1 represents examples of homomorphic encryption algorithms.

TABLE 1

| | Gentry's scheme | DGHV | BGV | BFV | CKKS |
|---|---|---|---|---|---|
| Year of issue | 2009 | 2010 | 2011 | 2012 | 2016 |
| Author | Craig Gentry | Van Dijk, | Brakerski, | Zvika | Jung Hee |
| | | Gentry, | Gentry and | Brakerski, | Cheon, |
| | | Halevi and | Vaikuntanathan | Junfeng Fan, | Andrey Kim, |
| | | Vaikuntanathan | | Vaikuntanathan | Miran Kim, |
| | | | | | and Yongsoo |
| | | | | | Song |
| Base problem | Ideal lattice | Approximate | RLWE scheme | RLWE scheme | RLWE scheme |
| | | GCD problem R | | | |
| Fully | Support | Support | Support | Support | Support |
| homomorphic | | | | | |
| operation | | | | | |
| support status | | | | | |
| Feature and | Proposed is | Due to integer | Efficiency is | Public key, | Homomorphic |
| advantage | the world's | calculation | better than | private key | encryption |
| | first fully | rather than | bootstrapping by | and | scheme |
| | homomorphic | lattice | using modulus | ciphertext | capable of |
| | encryption | calculation, | switching | key sizes are | performing |
| | scheme using | structural | technique. | independent | real and |
| | bootstrapping | simplicity is | RLWE-based | of lattice | complex number |
| | scheme of | present | problem, | (RLWE) | operations |
| | generating | (relatively easy | superior than | dimension. | Available as |
| | fully | to implement). | existing in terms | Using | fully |
| | homomorphic | | of safety | modulus | homomorphic |
| | encryption | | | switching | encryption |
| | from partial | | | technique | through |
| | homomorphic | | | | bootstrapping |
| | encryption | | | | More packing is |
| | (somewhat). | | | | possible than |
| | | | | | BGV and BFV. |
| disadvantage | However, | Not efficient by | However, | However, | In the case of |
| | commercialization | using | due to lower | due to lower | decryption, |
| | is difficult | squashing and | performance than | performance than | error occurs |
| | since more than | bootstrapping | bootstrapping, | bootstrapping, | compared to |
| | tens of minutes | | such as CKKS, | such as CKKS, | actual value |
| | is used to | | there is limit in | there is limit in | (since it is |
| | perform 1-bit | | commercialization | commercialization | approximate |
| | operation. | | for multiplication | for multiplication | operation). |
| | | | operation. | operation. | |

The following Table 2 represents examples of libraries.

TABLE 2

| | Manufacturing | Base | |
|---|---|---|---|
| Library | company | scheme | Feature |
| SEAL | Microsoft | BFV/CKKS | BFV: Modular operation is possible in |
| | | | encrypted integers. |
| | | | CKKS: Real number operation is possible. |
| HELib | IBM | BGV/CKKS | BGV: Based on BGV (/w Smart |
| | | | Vercauteren packing, Gentry-Helevi-Smart |
| | | | optimization) cryptographic structure that |
| | | | is most efficient for polynomial operations |
| | | | CKKS: Real number operation is possible. |
| HEaaN | CryptoLab | CKKS | Provide bootstrap-possible CKKS |
| | | | operation |
| PALISADE | Duality | BFV/CKKS/ | Provide various functions, such as |
| | Technology | TFHE | electronic signature, ID-based encryption |
| | | | function, etc. |

Hereinafter, an example of an operation providable through an HEaaN library is described. Performance of each operation may vary depending on the version of a library. The performance of each operation is an example of performance of a direct operation on titanic data (7 columns and 500 rows) in seconds on a p40 (GPU) server that is a private server.

Hereinafter, a key generation operation is described.

A key for encryption and/or decryption may be divided into two types of keys, for example, a key of depth 7 and a key of depth full according to the number of multiplication operations allowed. Key generation may be performed on a CPU server. The following Table 3 represents the key generation operation.

TABLE 3

| | | | Number of |
|---|---|---|---|
| | | | multiplication |
| Class. | Depth | Performance | operations allowed |
| Key | 7 | 3 sec | Maximum 7 times |
| generation | full | 28 sec | Unlimited |

Although Table 3 describes two types of keys, various keys may be generated according to the depth. In this case, encryption and decryption operations described below may be performed using keys of various depths.

Hereinafter, an encryption operation and a decryption operation are described.

Table 4 represents the encryption operation and Table 5 represents the decryption operation. The encryption may be performed on the CPU server.

TABLE 4

| Class. | Depth | Performance | Used key |
|---|---|---|---|
| Encryption | 7 | In 1 sec | Depth 7 |
| | full | In 2 sec | Depth full |

TABLE 5

| Class. | Depth | Performance | Used key |
|---|---|---|---|
| Decryption | 7 | In 1 sec | Depth 7 |
| | full | In 1 sec | Depth full |

Hereinafter, a general operation is described.

Examples of the generation operation may include a constant operation for constant data, a column operation for matrix-type data, a statistical operation using the matrix-type data for statistics of a target, a categorical operation for processing an operation on values that meet a condition among values of a specific column, and a machine learning operation for learning and inference of machine learning.

Table 6 represents the column operations.

TABLE 6

| Class. | Operation | Performance | Note |
|---|---|---|---|
| Basic | Column addition | 9 sec | Addition between columns |
| arithmetic | | | is possible. |
| operation | Column | 10 sec | Subtraction between |
| | subtraction | | columns is possible. |
| | Column | 11 sec | Multiplication between |
| | multiplication | | columns is possible. |
| Constant | Column constant | 10 sec | Addition between column |
| operation | addition | | and constant is possible. |
| | Column constant | 10 sec | Subtraction between |
| | subtraction | | column and constant is |
| | | | possible. |
| | Column constant | 8 sec | Multiplication between |
| | multiplication | | column and constant is |
| | | | possible. |

Table 7 represents the statistical operations.

TABLE 7

| Class. | Operation | Performance | | Note |
|---|---|---|---|---|
| Bootstrap | SUM | 29 | sec | Sum |
| not required | AVG | 28 | sec | Average |
| | VAR | 43 | sec | Variance |
| Bootstrap | SD | 103 | sec | Standard deviation |
| required | SE | 112 | sec | Standard error |
| | CV | 183 | sec | Coefficient of variation |
| | skewness | 81 | sec | Skewness |
| | Kurtosis | 151 | sec | Kurtosis |
| | max | 107 | sec | Maximum value |
| | min | 108 | sec | Minimum value |
| | range | 228 | sec | Range (maximum value + |
| | | | | minimum value) |
| | abs | 156 | sec | Absolute value |
| | corr | 109 | sec | Correlation coefficient |
| | cov | 33 | sec | Covariance |

The following Table 8 represents the statistical operations.

TABLE 8

| Class. | Operation | Performance | Note |
|---|---|---|---|
| Bootstrap | Filter | 10 sec | Function of selecting values that meet |
| not required | | | the condition |
| | MERGE | 10 sec | Merge values that meet the condition. |
| | COUNT | 19 sec | Return number of values that meet the |
| | | | condition. |
| | SUM | 47 sec | Sum of values that meet the condition. |
| | AVG | 60 sec | Average of values that meet the |
| | | | condition. |
| | VAR | 74 sec | Variance of values that meet the |
| | | | condition. |
| Bootstrap | SD | 126 sec | Standard deviation of values that meet |
| required | | | the condition. |
| | SE | 95 sec | Standard error of values that meet the |
| | | | condition. |
| | CV | 71 sec | Coefficients of variation of values that |
| | | | meet the condition. |
| | skewness | 61 sec | Skewness of values that meet the |
| | | | condition. |
| | Kurtosis | 71 sec | Kurtosis of values that meet the |
| | | | condition. |
| | abs | 76 sec | Absolute values of values that meet the |
| | | | condition. |

Table 9 represents the machine learning operations.

TABLE 9

| Class. | Operation | Performance | Note |
|---|---|---|---|
| Learning | Logistic regression | 240 sec | Bootstrap required |
| | learning | | |
| Constant | Plaintext model | 18 sec | Bootstrap required (X) |
| operation | inference | | |
| | Encrypted model | 38 sec | Bootstrap required |
| | inference | | |

As described above, the existing encryption technologies have technical limitation in that, if statistical analysis of certain encrypted data is to be performed, a corresponding task needs to be performed with the plaintext acquired after decryption. On the contrary, the homomorphic encryption enables an operation of the plaintext in an encrypted state and accordingly, may directly perform various tasks on encrypted data. The computing device providing method according to example embodiments may provide a service capable of processing a homomorphic encryption operation with a PaaS scheme by recommending and providing a computing device provisioned with an environment for processing of the homomorphic encryption operation according to computing power suitable for the homomorphic encryption operation desired by the user.

As described above, by dynamically configuring and providing a computing device for processing of a homomorphic encryption operation through a cloud environment, it is possible to provide a computing device suitable for a characteristic of the homomorphic encryption operation, such as a characteristic in which performance significantly differs in a CPU environment and a GPU environment according to an operation, or a characteristic in which a size of a key or a size of ciphertext varies according to depth. That is, infrastructure resources may be flexibly operated in a cloud environment. Since the computing device having suitable computing power is providable according to the type of a key to be generated, the size of data to be processed through the homomorphic encryption operation, the type of the homomorphic encryption operation, and the operation speed expected by the user, unnecessary resources and cost may be saved.

As described above, according to some example embodiments, it is possible to provide a computing device required for an operation using homomorphic encryption in a cloud environment. Also, it is possible to predict computing power required for an operation using homomorphic encryption and to recommend a computing device for each computing power based on the predicted computing power.

The systems or the apparatuses described herein may be implemented using hardware components, or a combination of hardware components and software components. For example, the apparatuses and the components described herein may be implemented using one or more processing devices, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to the example embodiments may be recorded in non-transitory computer-readable media including program instructions executable through various computer methods. The media may also include, alone or in combination with the program instructions, data files, data structures, and the like. The media may continuously store computer-executable programs or may transitorily store the same for execution or download. Also, the media may be various types of recording devices or storage devices in a form in which one or a plurality of hardware components are combined. Without being limited to a media directly connected to a computer system, the media may be distributed over the network, Examples of non-transitory computer-readable media include magnetic media such as hard disks, floppy disks, and magnetic tapes; optical media such as CD ROM disks and DVD; magneto-optical media such as floptical disks; and hardware devices that are specially designed to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software. Examples of program instructions include both machine code, such as produced by a compiler, and files containing higher level code that may be executed by the computer using an interpreter.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computing device providing method performed by a computer device having at least one processor and implementing at least one node in a cloud environment, the method comprising:
providing, to a client device, a management tool including an application function of a computing device for processing a homomorphic encryption operation; and
recommending, to the client device, the computing device for processing of the homomorphic encryption operation requested through the management tool.

2. The computing device providing method of claim 1, wherein the computing device includes a virtual device provisioned with an environment for processing of the homomorphic encryption operation.

3. The computing device providing method of claim 2, wherein the environment for processing of the homomorphic encryption operation includes an environment in which a library for the homomorphic encryption is installed.

4. The computing device providing method of claim 1, wherein the recommending of the computing device is based on at least one of a type of the homomorphic encryption operation, a number of homomorphic encryption operations, a homomorphic encryption scheme, and a type of a parameter of homomorphic encryption.

5. The computing device providing method of claim 4, wherein the type of the parameter is classified according to at least one of a number of multiplication operations allowed, a speed of the homomorphic encryption operation, an accuracy of the homomorphic encryption operation, a capacity of homomorphic ciphertext, and an availability of bootstrap.

6. The computing device providing method of claim 4, wherein the recommending of the computing device further comprises recommending the computing device for processing of the requested homomorphic encryption operation based on at least one of a size of data for the homomorphic encryption operation and an execution time expected for processing the homomorphic encryption operation.

7. The computing device providing method of claim 1, wherein the homomorphic encryption operation processed by the computing device includes an operation that requires bootstrap and an operation that does not require rebooting.

8. The computing device providing method of claim 1, wherein the homomorphic encryption operation processed by the computing device includes at least one operation among a constant operation for constant data, a column operation for matrix-type data, a statistical operation using the matrix-type data for statistics of a target, a categorical operation for processing an operation on values that meet a condition among values of a specific column, and a machine learning operation for learning and inference of machine learning.

9. The computing device providing method of claim 1, wherein the computing device providing method further comprises, in response to a selection on the recommended computing device through the management tool, providing a virtual image of the selected computing device to the client device.

10. The computing device providing method of claim 1, wherein the management tool further includes a key generation function for generation of a key.

11. The computing device providing method of claim 1, wherein the management tool further includes encryption and decryption functions for encryption and decryption of data for the homomorphic encryption operation.

12. The computing device providing method of claim 1, wherein the management tool further includes a return function of the computing device and a history management function according to application and return of the computing device.

13. A non-transitory computer-readable recording medium storing instructions that, when executed by a processor, cause the processor to perform the computing device providing method of claim 1.

14. A computer device comprising:
at least one processor configured to execute computer-readable instructions in the computer device that implements at least one node included in a cloud environment,
wherein the at least one processor is configured to:
provide, to a client device, a management tool including an application function of a computing device that processes a homomorphic encryption operation, and
recommend, to the client device, the computing device that processes the homomorphic encryption operation requested through the management tool.

15. The computer device of claim 14, wherein the computing device includes a virtual device provisioned with an environment for processing of the homomorphic encryption operation.

16. The computer device of claim 14, wherein, the requested homomorphic encryption operation is recommended based on at least one of a size of data for the homomorphic encryption operation, a type of the homomorphic encryption operation, a number of homomorphic encryption operations, an execution time expected for processing the homomorphic encryption operation, a homomorphic encryption scheme, and a type of a parameter of homomorphic encryption.

17. The computer device of claim 14, wherein the homomorphic encryption operation processed by the computing device includes an operation that requires bootstrap and an operation that does not require rebooting.

18. The computer device of claim 14, wherein the homomorphic encryption operation processed by the computing device includes at least one operation among a constant operation for constant data, a column operation for matrix-type data, a statistical operation using the matrix-type data for statistics of a target, a categorical operation for processing an operation on values that meet a condition among values of a specific column, and a machine learning operation for learning and inference of machine learning.

19. The computer device of claim 14, wherein the at least one processor is configured to provide a virtual image of the selected computing device in response to a selection on the recommended computing device through the management tool.
